(19) United States
(12) Patent Application Publication
(10) Pub. No.: US 2004/0183932 A1
(43) Pub. Date: Sep. 23, 2004

(54) Solid state imaging device

(75) Inventor: Shigetaka Kasuga, Osaka (JP)

Correspondence Address: Jack Q. Lever, Jr., McDERMOTT, WILL & EMERY, 600 Thirteenth Street, N.W., Washington, DC, 20005-3096, US

(73) Assignee: MATSUSHITA ELECTRIC INDUSTRIAL CO., LTD.

(21) Appl. No.: 10/765,930

(22) Filed: Jan. 29, 2004

(30) Foreign Application Priority Data
Jan. 30, 2003 (JP) 2003-021375

(51) Int. Cl. H04N 5/335

(52) U.S. Cl. 348/301; 348/294

(57) ABSTRACT

The solid state imaging device of this invention includes a pixel unit for outputting, as an analog signal, a voltage signal corresponding to light and an AD converter for converting the analog signal output by the pixel unit into a digital signal. Transistors used in the pixel unit and the AD converter are all N-type MOS transistors. The AD converter includes a booster circuit.

### BACKGROUND OF THE INVENTION

The present invention relates to an NMOS solid state imaging device using N-type MOS transistors alone as transistors included therein, and more particularly, it relates to a technique to include an AD converter in an NMOS solid state imaging device for realizing a digital signal output function.

FIG. 16 is a block diagram for showing the internal configuration of a conventional CMOS solid state imaging device. As shown in FIG. 16, the CMOS solid state imaging device 10 includes a pixel unit 11 composed of a plurality of pixels 11a arranged in a matrix, a vertical scanning unit 12 for outputting a row selection signal for selecting an arbitrary pixel row in the pixel unit 11, and a horizontal scanning unit 13 for reading an analog signal output from each pixel belonging to the pixel row selected in accordance with the row selection signal. The vertical scanning unit 12 is connected to each pixel row of the pixel unit 11 through a first selection signal line 11b, and the horizontal scanning unit 13 is connected to each pixel column of the pixel unit 11 through a second selection signal line 11c. Also, a noise filtering unit 14 for removing noise from the analog signal output from each pixel of the pixel unit 11 is provided between the pixel unit 11 and the horizontal scanning unit 13. Moreover, the CMOS solid state imaging device 10 further includes an amplifier unit 15 for amplifying the analog signal read by the horizontal scanning unit 13, and an AD converter 16 for converting the analog signal having been amplified by the amplifier unit 15 into a digital pixel signal and outputting it to the outside (i.e., to a signal processor 20). The signal processor 20 transmits pulses and the like necessary for the operations of respective constitution elements of the CMOS solid state imaging device 10.

As compared with the case where an analog pixel signal is output, advantages of outputting a digital pixel signal are, for example, that an interface portion between the solid state imaging device and the signal processor typified by a DSP (Digital Signal Processor) is less influenced by noise and that the signal is less degraded. Therefore, many CMOS solid state imaging devices include AD converters (see, for example, Japanese Laid-Open Patent Publication No. 2000-286706 (pp. 2-5 and FIG. 1)).

Apart from conventional CCD solid state imaging devices and CMOS solid state imaging devices, development of NMOS solid state imaging devices has recently been started. In an NMOS solid state imaging device, N-type MOS transistors alone are used as transistors included in its circuits. Specifically, an NMOS solid state imaging device is expected to be a promising solid state imaging device that can be fabricated through a largely reduced number of processes necessary for forming wells and transistors in a substrate while keeping its imaging performances.

FIG. 17 is a block diagram for showing the internal configuration of a conventional NMOS solid state imaging device. As shown in FIG. 17, the NMOS solid state imaging device 30 includes a pixel unit 31 composed of a plurality of pixels 31a arranged in a matrix, a vertical scanning unit 32 for outputting a row selection signal for selecting an arbitrary pixel row in the pixel unit 31, and a horizontal scanning unit 33 for reading an analog signal output from each pixel belonging to the pixel row selected in accordance with the row selection signal. The vertical scanning unit 32 is connected to each pixel row of the pixel unit 31 through a first selection signal line 31b, and the horizontal scanning unit 33 is connected to each pixel column of the pixel unit 31 through a second selection signal line 31c. A noise filtering unit 34 for removing noise from the analog signal output from each pixel of the pixel unit 31 is provided between the pixel unit 31 and the horizontal scanning unit 33. Moreover, the NMOS solid state imaging device 30 further includes an amplifier unit 35 for amplifying the analog signal read by the horizontal scanning unit 33 and outputting the amplified analog signal to the outside (i.e., to a signal processor 40). The signal processor 40 transmits pulses and the like necessary for the operations of respective constitution elements of the NMOS solid state imaging device 30.

However, it is very difficult, from the viewpoint of keeping a conversion rate, to provide the NMOS solid state imaging device using N-type MOS transistors alone as transistors with equivalent functions to those of a CMOS solid state imaging device, and particularly to include an AD converter in the NMOS solid state imaging device. Specifically, as shown in FIG. 17, the conventional NMOS solid sate imaging device does not include an AD converter. Therefore, although an NMOS solid state imaging device is a promising solid state imaging device as described above, it can disadvantageously exhibit functions poorer than those of a CMOS solid state imaging device.

### SUMMARY OF THE INVENTION

In consideration of the aforementioned disadvantage, an object of the invention is including, in an NMOS solid state imaging device, a rapid AD converter having a circuit configuration including N-type MOS transistors alone.

In order to achieve the object, the solid state imaging device of this invention using N-type MOS transistors alone as transistors included therein, includes a pixel unit composed of a plurality of pixels arranged in a two-dimensional matrix, each of the pixels including a photoelectric converting element for generating charge in response to light and an amplifying element for outputting, as an analog signal, a voltage signal corresponding to the charge generated by the photoelectric converting element; a selection signal line provided correspondingly to each pixel row of the pixel unit; a comparison/storage unit provided correspondingly to each pixel column of the pixel unit for converting, into a digital signal, the analog signal output from the amplifying element included in each pixel belonging to a pixel row selected in the pixel unit and for storing the digital signal; a scanner for selecting and reading the digital signal stored in the comparison/storage unit in time series; and an amplifier for amplifying the read digital signal and outputting the amplified digital signal to the outside.

In the NMOS solid state imaging device of this invention, an analog signal output from the amplifying element of each pixel belonging to a pixel row selected in the pixel unit is rapidly converted into a digital signal in the comparison/storage unit. Therefore, the NMOS solid state imaging device can attain an AD conversion function equivalent to that of a CMOS solid state imaging device, and thus, the additional value of the NMOS solid state imaging device can be remarkably improved.

Preferably, in the solid state imaging device, the comparison/storage unit includes a comparator, which includes three inverter circuits using N-type MOS transistors alone and serially connected to one another, and a booster circuit for preventing voltage attenuation of an output signal and accelerating the output signal; in order to increase a fall speed of an inverter circuit disposed at the first stage out of the three inverter circuits, ON resistance of a transistor connected to GND potential is set to be smaller than ON resistance of a transistor connected to power potential in the inverter circuit disposed at the first stage; in order to increase a rise speed of an inverter circuit disposed at the second stage out of the three inverter circuits, ON resistance of a transistor connected to the power potential is set to be smaller than ON resistance of a transistor connected to the GND potential in the inverter circuit disposed at the second stage; and in order to increase a fall speed of an inverter circuit disposed at the third stage out of the three inverter circuits, ON resistance of a transistor connected to the GND potential is set to be smaller than ON resistance of a transistor connected to the power potential in the inverter circuit disposed at the third stage.

Thus, the comparator is provided with the booster circuit, and the fall speed from “High” level to “Low” level of the ultimate output characteristic of the inverter circuit disposed at the third stage of the comparator is increased. Therefore, even though N-type MOS transistors alone are used, problems of signal voltage level attenuation, consumption power increase and response speed lowering can be prevented.

Preferably, in the solid state imaging device, the comparison/storage unit includes a memory, which includes a first switch for reading a counter value on the basis of a signal supplied from the comparator, a capacitor for storing the read counter value, a second switch for transferring the counter value stored in the capacitor, a third switch for deleting the transferred counter value, a fourth switch for reading the transferred counter value on the basis of a signal supplied from the scanner, and the amplifier for outputting the read counter value to the outside, and the amplifier includes a booster circuit for preventing voltage attenuation of an output signal thereof and accelerating the output signal.

Thus, circuit elements can be shared in accordance with the operation characteristics thereof in the memory, resulting in reducing the circuit scale. Furthermore, since the amplifier is provided with the booster circuit, even though N-type MOS transistors alone are used, the problems of the signal voltage attenuation, the consumption power increase and the response speed lowering can be prevented, so that the NMOS solid state imaging device can attain performances at the practical levels.

Preferably, the solid state imaging device of this invention further includes a pulse generator for generating a pulse signal on the basis of a column selection signal output from a horizontal scanner included in the scanner; and a counter generator for generating the counter value on the basis of the pulse signal generated by the pulse generator.

Thus, a pulse generation circuit included in an external signal processor such as a DSP in a conventional solid state imaging device can be omitted. Also in this case, when the counter generator is provided with a booster circuit for preventing voltage attenuation of its output signal and accelerating the output signal, the problems of the signal voltage level attenuation, the consumption power increase and the response speed lowering can be more definitely prevented.

The solid state imaging device of this invention may further include a ramp waveform generator for generating a ramp signal on the basis of the pulse signal generated by the pulse generator and the counter value generated by the counter generator.

The alternative solid state imaging device of this invention includes a pixel unit formed on a semiconductor substrate and outputting, as an analog signal, a voltage signal corresponding to light; and an AD converter formed on the semiconductor substrate and converting the analog signal output from the pixel unit into a digital signal, and transistors included in the pixel unit and the AD converter are all N-type MOS transistors, and the AD converter includes a booster circuit.

In the alternative NMOS solid state imaging device, an analog signal output from the pixel unit is converted into a digital signal in the AD converter. Also, since the AD converter includes the booster circuit, voltage attenuation of its output pulse can be prevented and the output pulse can be accelerated. Therefore, the NMOS solid state imaging device can realize a rapid AD conversion function equivalent to that of a CMOS solid state imaging device, so that the additional value of the NMOS solid state imaging device can be remarkably improved.

Preferably, in the alternative solid state imaging device of this invention, the booster circuit includes a transistor whose source or drain is connected to power potential, and a voltage not less than the power potential is applied to a gate of the transistor.

Thus, the transistor of the booster circuit can be placed in a complete conductive state, and therefore, a signal at “High” level can be output while preventing the voltage attenuation.

Preferably, in the alternative solid state imaging device, the AD converter includes, in addition to the booster circuit, any or all of a comparator, a memory, a pulse generator and a counter generator.

Thus, a rapid AD converter can be definitely obtained.

In the case where the AD converter includes a comparator, the comparator may include an inverter circuit having the booster circuit, the booster circuit may include a first transistor whose source or drain is connected to power potential, and a voltage not less than the power potential may be applied to a gate of the first transistor.

Alternatively, in the case where the AD converter includes a comparator, the comparator may include an inverter circuit having the booster circuit, the inverter circuit may have a second transistor formed above a well region independent of other well regions, and a gate and a source of the second transistor may be electrically connected to the well region.

In the case where the AD converter includes a memory, the memory may include a plurality of switches, a capacitor and an output amplifier, the output amplifier may include a booster circuit, the booster circuit may have a transistor whose source or drain is connected to power potential, and a voltage not less than the power potential may be applied to a gate of the transistor. In this case, the memory may include a first switch for reading a counter value on the basis of a signal supplied from the comparator, a capacitor for storing the read counter value, a second switch for transferring the counter value stored in the capacitor, a third switch for deleting the transferred counter value, a fourth switch for reading the transferred counter value on the basis of a signal supplied from the scanner, and an output amplifier for outputting the read counter value to the outside.

In the case where the AD converter includes a pulse generator, the pulse generator generates a pulse signal on the basis of a column selection signal output from a horizontal scanner and may include a plurality of inverter circuits serially connected to one another, an inverter circuit disposed at the ultimate stage out of the plurality of inverter circuits may include a booster circuit, the booster circuit may have a transistor whose source or drain is connected to power potential, and a voltage not less than the power potential may be applied to a gate of the transistor.

In the case where the AD converter includes a counter generator, the counter generator generates a counter value on the basis of a pulse signal generated by the pulse generator and may include a plurality of inverter circuits each having a booster circuit, the. booster circuit may have a transistor whose source or drain is connected to power potential, and a voltage not less than the power potential may be applied to a gate of the transistor.

In this manner, according to the present invention, the NMOS solid state imaging device is provided with the rapid comparison/storage unit, that is, a rapid AD converter, that converts an analog signal output from the pixel unit into a digital signal and uses N-type MOS transistors alone. Therefore, even the NMOS solid state imaging device can include an AD converter equivalent to that used in a CMOS solid state imaging device, so that the additional value of the NMOS solid state imaging device can be remarkably improved.

In other words, the present invention relates to the technique to include an AD converter in a solid state imaging device, and is particularly useful in application to an NMOS solid state imaging device for realizing a digital signal output function.

### BRIEF DESCRIPTION OF THE DRAWINGS

FIG. 1 is a block diagram for showing the schematic configuration of an NMOS solid state imaging device according to an embodiment of the invention;

FIG. 2 is a block diagram for showing the schematic circuit configuration of a comparator used in the NMOS solid state imaging device according to the embodiment;

FIG. 3 is a block diagram for showing the detailed circuit configuration of the comparator used in the NMOS solid state imaging device according to the embodiment;

FIG. 4 is an operation timing chart of the comparator used in the NMOS solid state imaging device according to the embodiment;

FIG. 5 is a block diagram for showing the schematic circuit configuration of a memory used in the NMOS solid state imaging device according to the embodiment;

FIG. 6 is a block diagram for showing the detailed circuit configuration of the memory used in the NMOS solid state imaging device according to the embodiment;

FIG. 7 is an operation timing chart of the memory used in the NMOS solid state imaging device according to the embodiment;

FIG. 8 is a block diagram for showing the circuit configuration of a pulse generator used in the NMOS solid state imaging device according to the embodiment;

FIG. 9 is an operation timing chart of the pulse generator used in the NMOS solid state imaging device according to the embodiment;

FIG. 10 is a block diagram for showing the circuit configuration of a counter generator used in the NMOS solid state imaging device according to the embodiment;

FIG. 11 is a block diagram for showing the detailed configuration of a frequency divider used in the counter generator in the NMOS solid state imaging device according to the embodiment;

FIG. 12 is an operation timing chart of the counter generator used in the NMOS solid state imaging device according to the embodiment;

FIG. 13 is a block diagram for showing the circuit configuration of a DA converter used in the NMOS solid state imaging device according to the embodiment;

FIG. 14 is a block diagram for showing the circuit configuration of a ramp waveform generator used in the NMOS solid state imaging device according to the embodiment;

FIG. 15 is an operation timing chart of the ramp waveform generator used in the NMOS solid state imaging device according to the embodiment;

FIG. 16 is a block diagram for showing the schematic configuration of a conventional CMOS solid state imaging device;

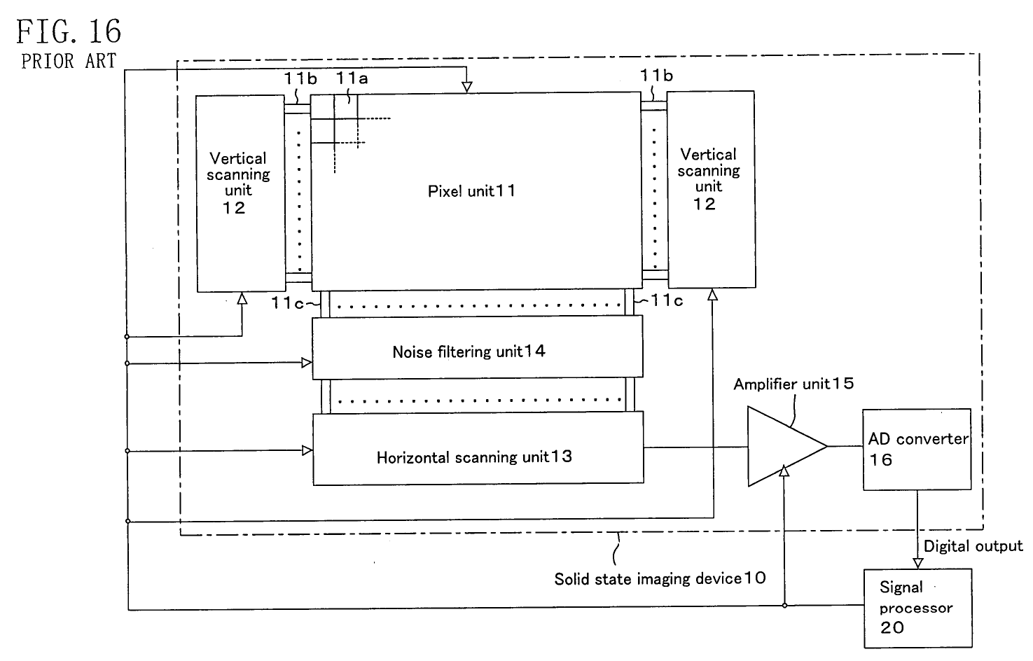

FIG. 17 is a block diagram for showing the schematic configuration of a conventional NMOS solid state imaging device; and

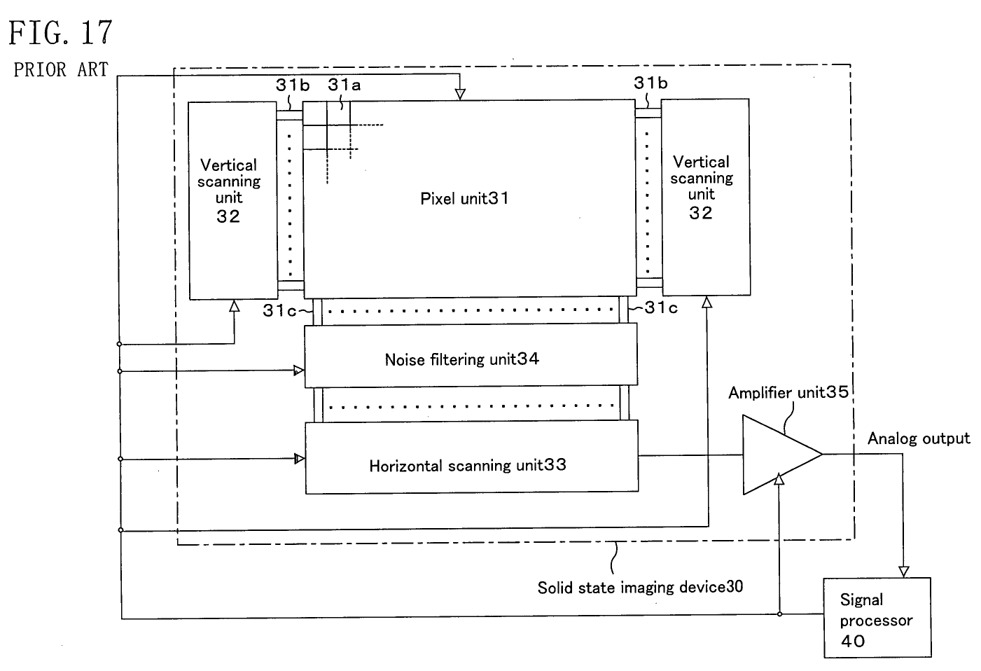

FIG. 18 is a cross-sectional view of a transistor used for constructing an inverter circuit included in the comparator used in the NMOS solid state imaging device according to the embodiment.

### DETAILED DESCRIPTION OF THE INVENTION

A solid state imaging device according to an embodiment of the invention, and specifically, an NMOS solid state imaging device that uses N-type MOS transistors alone as transistors included in its circuits and includes an AD converter, will now be described with reference to the accompanying drawings.

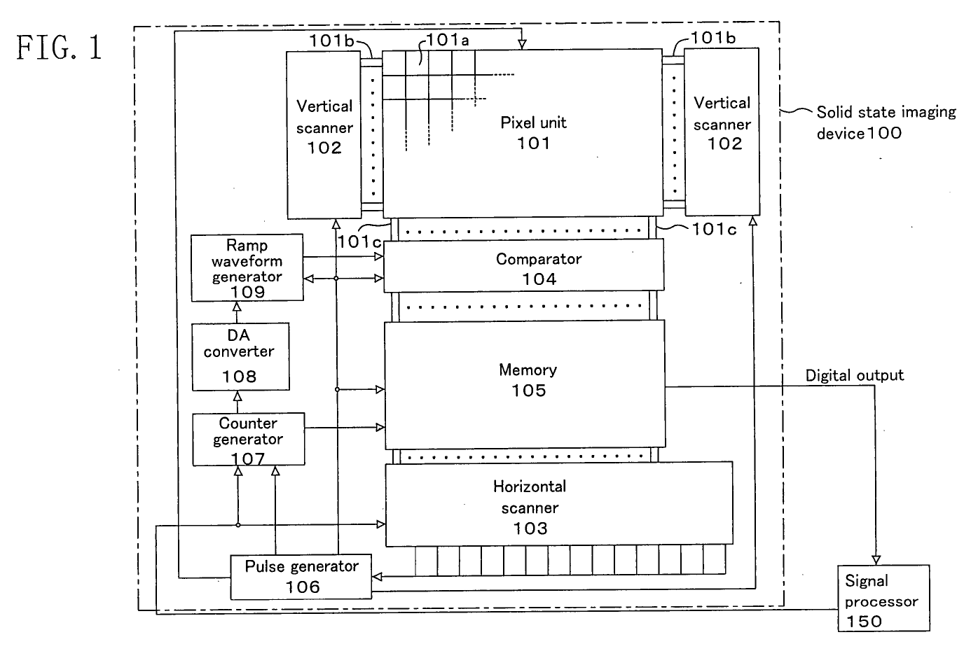

FIG. 1 is a block diagram for showing the schematic configuration of the NMOS solid state imaging device of this embodiment.

As shown in FIG. 1, the NMOS solid state imaging device 100 includes a pixel unit 101 composed of a plurality of pixels 101a arranged in a two-dimensional matrix, a vertical scanner 102 for outputting a row selection signal for selecting an arbitrary pixel row in the pixel unit 101, and a horizontal scanner 103 for outputting a column selection signal for selecting an arbitrary pixel column in the pixel unit 101. The vertical scanner 102 is connected to each pixel row of the pixel unit 101 through a first selection signal line 101b, and the horizontal scanner 103 is connected to each pixel column of the pixel unit 101 through a second selection signal line 110c. Although not shown in the drawing, each pixel 110a of the pixel unit 101 includes a photoelectric converter (such as a photo diode) for generating charge in response to light and an amplifier (such as an amplifier transistor) for outputting, as an analog signal, a voltage signal corresponding to the charge generated by the photoelectric converter.

As a characteristic of this embodiment, a comparison/storage unit (i.e., a comparator 104 and a memory 105) is provided between the pixel unit 101 and the horizontal scanner 103 correspondingly to each pixel column of the pixel unit 101. The comparison/storage unit converts an analog signal output from the amplifier of each pixel 101a belonging to the pixel row selected in the pixel unit 101 into a digital signal and stores the digital signal. Specifically, the comparator 104 reads an analog signal from each pixel 101a belonging to the pixel row selected in accordance with the row selection signal, and synthesizes the read analog signal with a ramp signal so that the synthesized signal can be compared with a reference voltage. Also, the memory 105 accepts, as an input, the comparison result obtained by the comparator 104, and stores a counter value on the basis of the comparison result and reads, as a digital signal, the stored counter value in time series on the basis of the column selection signal. As described later, the memory 105 includes an amplifier for amplifying the digital signal and outputting the amplified digital signal to the outside (i.e., to a signal processor 150).

As another characteristic of this embodiment, the NMOS solid state imaging device 100 further includes a pulse generator 106 for generating a pulse signal on the basis of the column selection signal supplied by the horizontal scanner 103; a counter generator 107 for generating the counter value necessary for the memory 105 on the basis of the pulse signal supplied by the pulse generator 106; a DA converter 108 for generating an analog signal on the basis of the counter value supplied by the counter generator 107; and a ramp waveform generator 109 for generating the ramp signal necessary for the comparator 104 on the basis of the analog signal supplied by the DA converter 108 and the pulse signal supplied by the pulse generator 106. The pulse generator 106 transmits the pulse signal also to the pixel unit 101, the vertical scanner 102, the comparator 104 and the memory 105. Also, the signal processor 150 provided outside the NMOS solid state imaging device 100 transmits given signals to the horizontal scanner 103 and the counter generator 107.

In this manner, the comparator 104, the memory 105, the pulse generator 106 and the counter generator 107 together form an AD converter in this embodiment, but the configuration of the AD converter is not limited to this. For example, there is no need for the AD converter to include all of the comparator 104, the memory 105, the pulse generator 106 and the counter generator 107. Also, as described later, the AD converter preferably includes a booster circuit.

Now, the respective constitution elements of the NMOS solid state imaging device 100, that is, specifically, the comparator 104, the memory 105, the pulse generator 106, the counter generator 107, the DA converter 108 and the ramp waveform generator 109, will be described in detail. As a premise of the following description, the respective constitution elements (such as the pixel unit and the AD converter) of the NMOS solid state imaging device 100 are formed on one and the same chip (namely, on one semiconductor substrate).

First, the comparator 104 will be described. As shown in FIG. 1, the comparator 104 generates the synthesized signal from the analog pixel signal output from each column of the pixel unit 101 and the ramp signal output from the ramp waveform generator 109, compares the synthesized signal with the reference voltage generated within the comparator 104 and rapidly transfers the comparison result to the memory 105. Transistors included in the comparator 104 are N-type MOS transistors alone, and in this embodiment, in order to prevent problems of signal voltage level attenuation, power consumption increase, response speed lowering and the like peculiar to a circuit composed of N-type MOS transistors, the comparator 104 is provided with circuital specific means as follows: The comparator 104 uses three inverter circuits connected in series to one another. In this case, among the three inverter circuits, one disposed at the input initial stage (namely, the first stage) is designed, in order to increase its fall speed, so that the ON resistance of a transistor connected to GND potential can be relatively small and the ON resistance of a transistor connected to power potential can be relatively large. Also, the inverter circuit disposed at the second stage is designed, in order to increase its rise speed, so that the ON resistance of a transistor connected to power potential can be relatively small and the ON resistance of a transistor connected to GND potential can be relatively large. In addition, the inverter circuit disposed at the third stage is designed, in order to increase its fall speed, so that the ON resistance of a transistor connected to GND potential can be relatively small and the ON resistance of a transistor connected to power potential can be relatively large. Furthermore, in order to prevent the voltage attenuation of its output pulse and to accelerate the output pulse, the comparator 104 includes a booster circuit. Since the circuit is thus designed with emphasis placed on the increase of the fall speed from “High” level to “Low” level of the ultimate output characteristic of the inverter circuit disposed at the third stage, even though N-MOS transistors alone are used in the circuit, the signal voltage level can be kept, the consumption power can be reduced and the response speed can be increased so as to attain performances at practical levels.

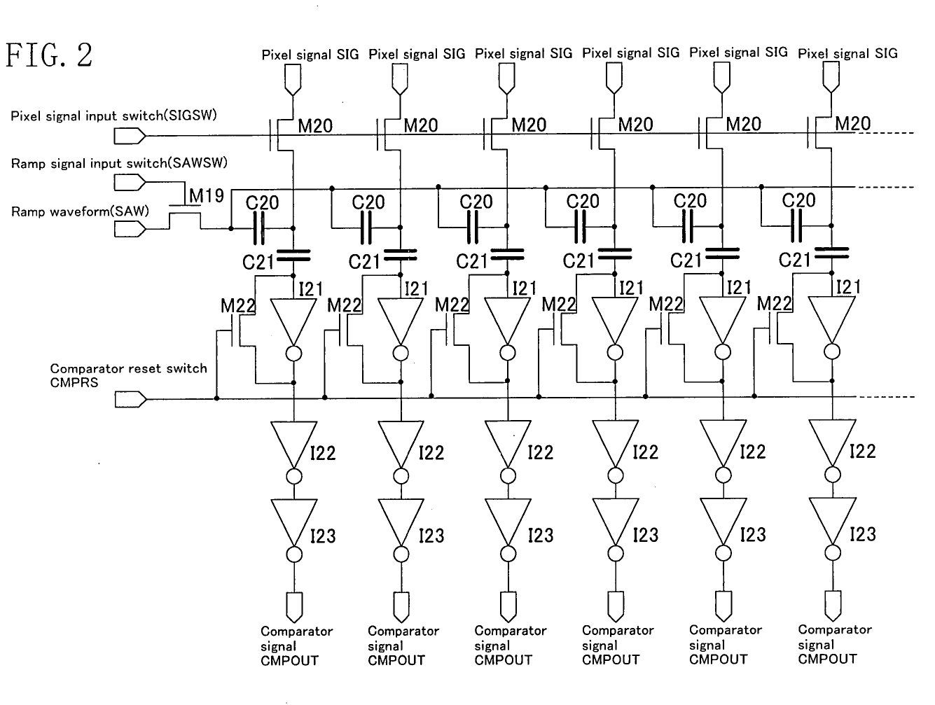

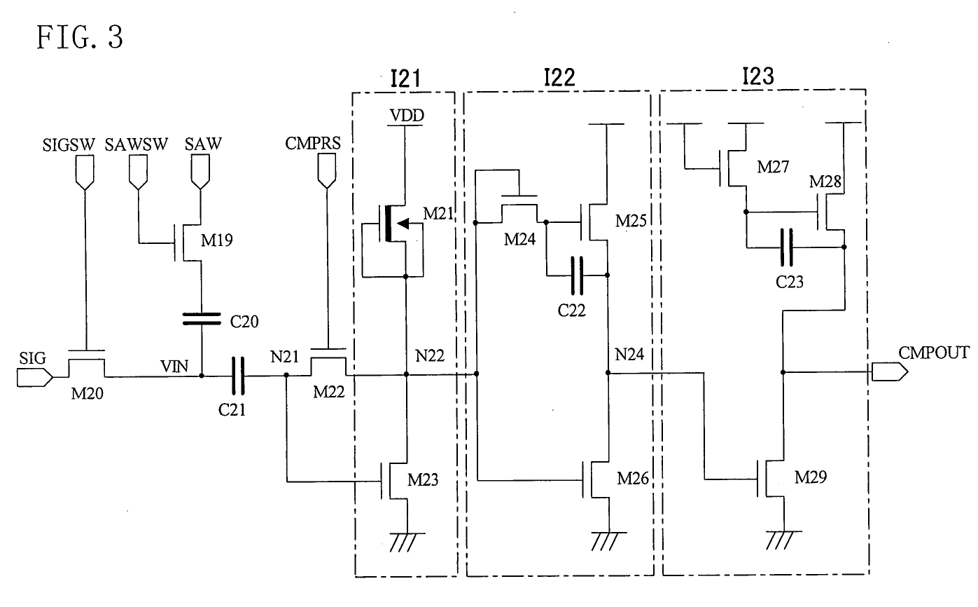

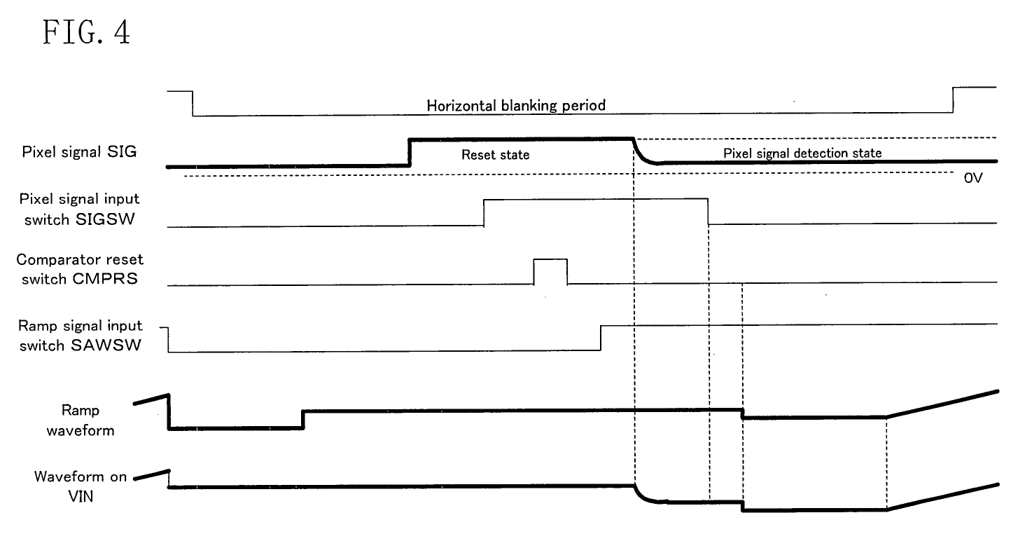

FIG. 2 is a block diagram for showing an example of the circuit configuration (of a portion corresponding to six pixel columns) of the comparator 104 of this embodiment, FIG. 3 is a block diagram for showing the detailed circuit configuration of a portion corresponding to one pixel column of the comparator 104 of FIG. 2, and FIG. 4 is an operation timing chart of the comparator 104 of FIG. 2. In FIGS. 2 and 3, M19 through M29 indicate N-type MOS transistors, C20 through C23 indicate capacitors and I21 through I23 indicate inverter circuits.

As shown in FIGS. 2 through 4, in the comparator 104, first, when a pixel signal input switch SIGSW is set to “High” level with an analog pixel signal SIG held at a reset level in a horizontal blanking period, the transistor M20 is turned on so as to input the pixel signal SIG at the reset level. Next, when a comparator reset switch CMPRS is set to “High” level, the transistor M22 is turned on so as to remove threshold variation of the transistor M23 and threshold variation of the amplifier transistors of the respective pixels, and then, the pixel signal SIG is read from the photodiode of each pixel. Thereafter, when a ramp signal input switch SAWSW is set to “High” level, the transistor M19 is turned on so as to input a ramp signal, and thus, a synthesized signal of the ramp signal and the pixel signal SIG is allowed to appear on a node VIN (see FIG. 3). At this point, the ramp waveform is adjusted so that the initial value of the voltage on the node VIN can be always lower than the threshold variation of the transistor M23. Subsequently, as the ramp signal is linearly swept, the voltage on the node VIN also increases, and when the voltage on the node VIN becomes higher than the threshold voltage of the transistor M23, potential on a node N22 becomes “Low” level, potential on a node N24 becomes “High” level and a comparator output signal CMPOUT undergoes a “Low” transition.

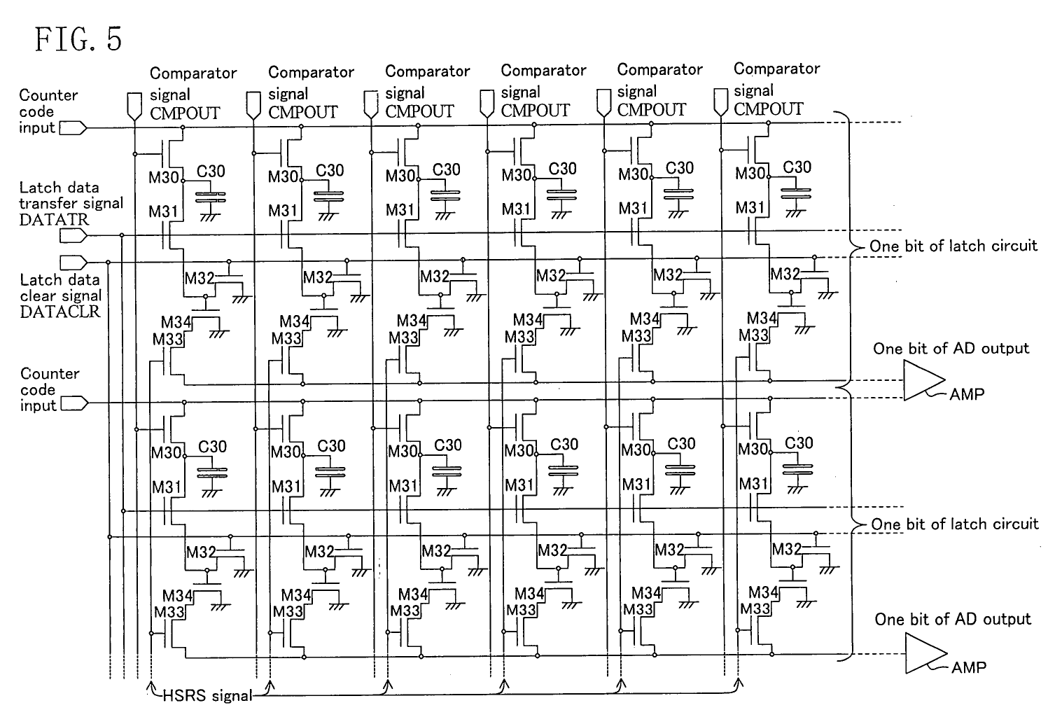

Significant points to be realized by the comparator 104 are that “High” level corresponding to the initial value of the comparator output signal CMPOUT is power voltage (power potential) level, and that the fall speed of the comparator output signal CMPOUT from “High” level to “Low” level is as fast as possible. This is because, in the memory 105 (see FIG. 5) disposed at the subsequent stage of the comparator 104, an N-type MOS transistor M30 is controlled in accordance with the comparator output signal CMPOUT so as to store a counter value.

Therefore, in this embodiment, the dimensions of the three stages of inverter circuits I21 through I23 all using N-MOS transistors alone is devised. Specifically, the inverter circuits are designed with emphasis placed on the fall characteristic in the inverter circuit I21 disposed at the first stage, with emphasis placed on the rise characteristic in the inverter circuit I22 disposed at the second stage, and with emphasis placed on the fall characteristic in the inverter circuit I23 disposed at the third stage.

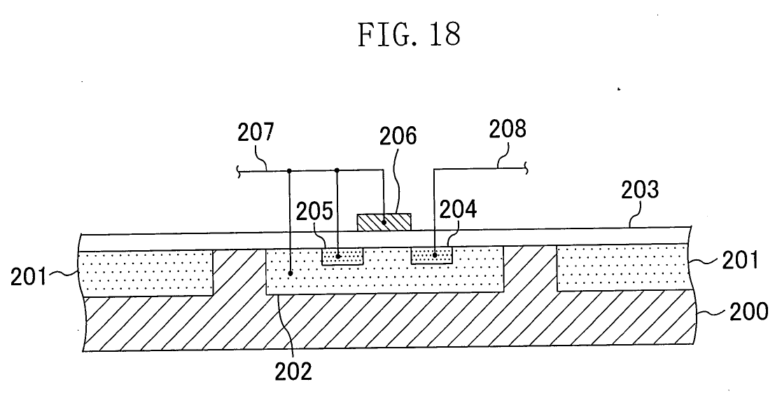

More specifically, in the inverter circuit I21 disposed at the first stage, the ON resistance of the transistor M23 is reduced by making the gate length relatively small and the gate width relatively large in the transistor M23 used for driving to “Low” level, and thus, the fall speed of the inverter circuit I21 disposed at the first stage can be increased. On the other hand, the ON resistance of the transistor M21 is increased by making the gate length relatively large and the gate width relatively small in the transistor M21 used for driving to “High” level, and thus, the current is reduced. Since the transistor M21 of the inverter circuit I21 is a depletion type transistor, the “High” potential in the inverter circuit I21 disposed at the first stage and provided with the booster circuit is the same as the power potential (i.e., the power voltage VDD). FIG. 18 is a cross-sectional view of the transistor M21 included in the inverter circuit I21 disposed at the first stage. As shown in FIG. 18, in a semiconductor substrate 200 of the same conductivity type as that of the transistor M21, namely, a semiconductor substrate 200 on which the NMOS solid state imaging device 100 of this embodiment is built, wells 201 and 202 of a conductivity type different from that of the semiconductor substrate 200 are formed. In this case, the well 202 is independent of the well 201. Also, an N-type MOS transistor other than the transistor M21 is formed above the well 201, and the transistor M21 alone is formed above the well 202. Specifically, a gate electrode 206 is formed above the well 202 with an insulating film 203 sandwiched therebetween. Also, on both sides of the gate electrode 206 in the well 202, a drain region 204 and a source region 205 are formed. Furthermore, the source region 205 and the gate electrode 206 of the transistor M21 are set to have the same potential as the well 202 through an interconnect 207. Although not shown in the drawing, the source region 205 and the gate electrode 206 are connected to the drain of the transistor M23 through the interconnect 207. Furthermore, the drain region 204 of the transistor M21 is connected to the power source through an interconnect 208.

Also, in the inverter circuit 122 disposed at the second stage, the ON resistance of the transistor M25 is reduced by making the gate length relatively small and the gate width relatively large in the transistor M25 used for driving to “High” level. Furthermore, when the inverter I21 disposed at the first stage outputs a signal at “High” level, the transistor M24 is turned on so that a voltage obtained by subtracting the threshold voltage of the transistor M24 from the power potential VDD can be applied to the gate of the transistor M25. Moreover, when the inverter circuit I21 outputs a signal at “Low” level, a voltage boosted to exceed the power voltage VDD is applied to the gate of the transistor M25, and hence the transistor M25 becomes completely conductive. In other words, the inverter circuit I22 is provided with the booster circuit having the transistor M25 whose source or drain is connected to the power potential VDD. As a result, the rise speed of the inverter circuit I22 disposed at the second stage can be increased without causing the voltage attenuation. On the other hand, the ON resistance of the transistor M26 is increased by making the gate length relatively large and the gate width relatively small in the transistor M26 used for driving to “Low” level, and thus, the current is reduced.

Moreover, in the inverter circuit 123 disposed at the third stage, the ON resistance of the transistor M29 is reduced by making the gate length relatively small and the gate width relatively large in the transistor M29 used for driving to “Low” level, and thus, the fall speed of the inverter circuit 123 disposed at the third stage is increased. On the other hand, the ON resistance of the transistor M28 is increased by making the gate length relatively large and the gate width relatively small in the transistor M28 used for driving to “High” level, and thus, the current is reduced. It is noted that a voltage obtained by subtracting the threshold voltage of the transistor M27 from the power potential VDD is applied to the gate of the transistor M28 in order to output a signal at “High” level without attenuating it to be smaller than the power potential VDD. Also, when the inverter circuit 122 disposed at the second stage outputs a signal at “Low” level, a voltage boosted to exceed the power potential VDD is applied to the gate of the transistor M28, and hence, the transistor M28 becomes completely conductive. In other words, the inverter circuit I23 is provided with the booster circuit having the transistor M28 whose source or drain is connected to the power potential VDD. In this manner, a signal at “High” level can be output without causing the voltage attenuation.

Through the circuit design described above, the fall speed of the comparator output signal CMPOUT of the comparator 104 can be improved and the power consumption of the comparator 104 can be reduced.

Next, the memory 105 will be described. As shown in FIG. 1, the memory 105 interrupts the counter value input from the counter generator 107 in accordance with a “Low” signal output as a result of the comparison operation of the comparator 104, and stores the counter value input at the interruption in a counter value storage capacitor. Also, the memory 105 reads the stored counter value in time series in accordance with the pulse (the column selection signal) supplied from the horizontal scanner 103 and successively outputs the read counter value through an output amplifier to the outside (the signal processor 150) as a digital signal. At this point, since transistors included in the memory 105 are all N-type MOS transistors as in the comparator 104, the memory 105 includes a booster circuit in order to prevent the problems of the signal voltage level attenuation, the consumption power increase and the response speed lowering, so as to attain performances at the practical levels. Furthermore, in order to reduce the circuit scale, circuit elements included in the memory 105 are shared as much as possible on the basis of the characteristics of their operations.

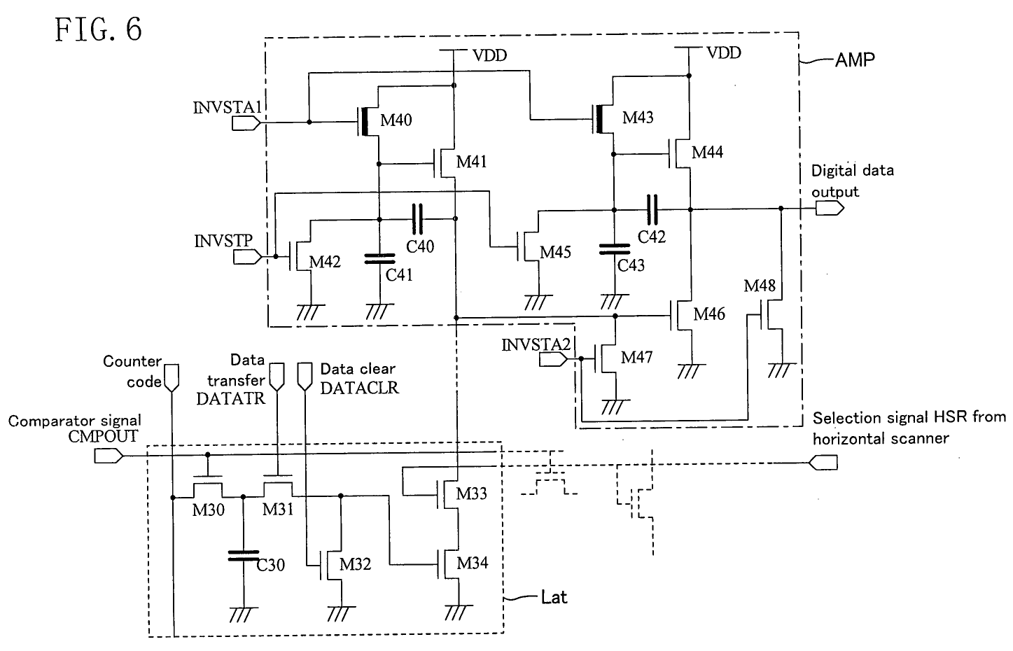

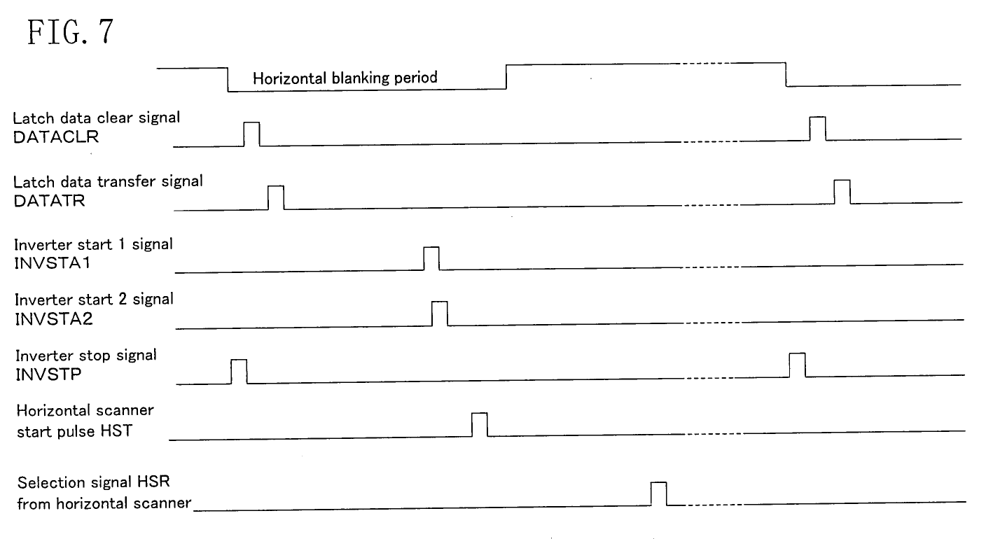

FIG. 5 is a block diagram for showing an example of the circuit configuration (of a portion corresponding to six pixel columns) of the memory 105 of this embodiment, FIG. 6 is a block diagram for showing the detailed circuit configuration of a portion corresponding to one pixel column of the memory 105 of FIG. 5, and FIG. 7 is an operation timing chart of the memory 105 of FIG. 5. In FIGS. 5 and 6, M30 through M34 and M40 through M48 indicate N-type MOS transistors, C30 and C40 through C43 indicate capacitors, Lat indicates a latch circuit and AMP indicates an amplifier.

As shown in FIGS. 5 through 7, in the latch circuit Lat of the memory 105, first, when the comparator output signal COMPOUT from the comparator 104 undergoes a “Low” transition in a horizontal blanking period, the transistor M30 is turned off, so that a counter code (a digital value) supplied from the counter generator 107 can be sampled to be pre-fetched by the pre-fetching capacitor C30. Next, when a latch data transfer signal DATATR undergoes a “High” transition, the transistor M31 is turned on, so that the pre-fetched counter code can be applied to the gate of the transistor M34. In this manner, data reversed to the counter code data (namely, inverted data) appears on the drain (on the side of the transistor M33) of the transistor M34. A pulse (a column selection signal HSR) supplied from the horizontal scanner 103 is successively applied to the gate of the transistor M33, and as a result, the inverted data of the pre-fetched counter code is input as a time series signal to the amplifier AMP that outputs inverted data. After the inverted data of the counter code is input to the amplifier AMP, a data clear signal DATACLR undergoes a “High” transition so as to clear charge of each pre-fetching capacitor C30, and the transistor M32 is turned on.

Next, in the amplifier AMP provided in the memory 105 for externally outputting a digital value resulting from AD conversion, an operation start pulse (an inverter start 1 signal) INVSTA1 for operating an inverter circuit disposed at the first stage is turned on, and subsequently, an operation start pulse (an inverter start 2 signal) INVSTA2 for operating an inverter circuit disposed at the second stage is turned on. Thus, the amplifier AMP can be previously placed in an operation state. At this point, as described above, the transistor M33 is turned on through the “High” transition of the column selection signal HSR supplied from the horizontal scanner 103 and the pre-fetched counter code is input to the amplifier AMP through the transistor M33 as a digital signal. In this manner, the digital signal obtained by converting the analog pixel signal is ultimately amplified by the amplifier AMP to be output to the outside. In the amplifier AMP, the consumption power can be reduced by using an inverter operation stop pulse (an inverter stop signal) INVSTP when the amplifying operation is not necessary. Furthermore, since the inverter circuit included in the amplifier AMP has a booster circuit, “High” level can be set to the power potential, and hence, the voltage attenuation of the output signal can be prevented and the output signal can be accelerated. The specific operation of the booster circuit is as follows: When the inverter start 1 signal INVSTA1 is turned on, voltages respectively obtained by subtracting the threshold voltages of the transistors M40 and M43 from the power potential VDD are respectively applied to the gates of the transistors M41 and M44 included in the booster circuit of each inverter circuit. When potential at the gate of the transistor M34 becomes “Low”, a voltage boosted to exceed the power potential VDD is applied to the gate of the transistor M41, and therefore, the transistor M41 becomes completely conductive. Accordingly, a signal at “High” level can be output without causing the voltage attenuation. Similarly, when potential at the gate of the transistor M34 becomes “High”, a voltage boosted to exceed the power potential VDD is applied to the gate of the transistor M44, and therefore, the transistor M44 becomes completely conductive. Therefore, a signal at “High” level can be output without causing the voltage attenuation. The source or the drain of each of the transistors M41 and M44 is connected to the power potential VDD.

When the above-described booster circuit is used, the rise speed for outputting a signal at “High” level can be easily increased, but the fall speed for outputting a signal at “Low” level is difficult to increase. Therefore, in this embodiment, the gate lengths of the transistor M34 for driving the output of the latch circuit Lat to “Low” level and the transistor M46 for driving the output of the amplifier AMP to “Low” level are made relatively small, and the gate widths of these transistors M34 and M46 are made relatively large. Thus, the ON resistances of these transistors are reduced, so that the fall speed can be increased.

Next, the pulse generator 106 will be described. As shown in FIG. 1, the pulse generator 106 generates a timing pulse necessary for the AD conversion through synthesis of the output pulse (the column selection signal) supplied from the horizontal scanner 103, and inputs the generated pulse to the counter generator 107 disposed at the subsequent stage.

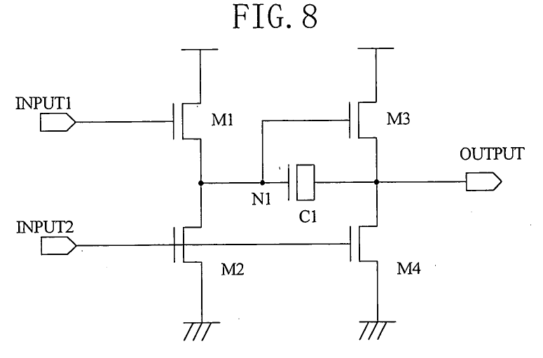

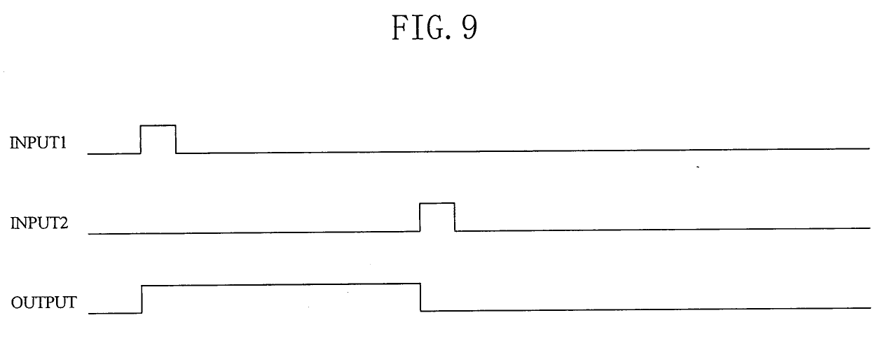

FIG. 8 is a block diagram for showing an example of the circuit configuration of the pulse generator 106 of this embodiment, and FIG. 9 is an operation timing chart of the pulse generator 106 of FIG. 8. In FIGS. 8 and 9, M1 through M4 indicate N-type MOS transistors and C1 indicates a capacitor.

As shown in FIGS. 8 and 9, the pulse generator 106 of this embodiment generates a new pulse by using fall edges of two kinds of pulses output in time series from the horizontal scanner 103. Also, the pulse generator 106 includes a plurality of inverter circuits (that is, inverter circuits of two stages in this embodiment) connected in series to one another, and a booster circuit is provided to the inverter circuit at the ultimate stage out of the plural inverter circuits. Specifically, in the pulse generator 106, when an input signal INPUT1 supplied from the horizontal scanner 103 undergoes a “High” transition, the transistor M1 is turned on, and therefore, a voltage [the power potential VDD—the threshold voltage of the transistor M1] is applied to the bootstrap capacitor C1 to charge the capacitor C1 and this voltage is also applied to the gate of the transistor M3. Therefore, a voltage [the power potential VDD—the threshold voltage of the transistor M3] appears as an output signal OUTPUT of the pulse generator 106. Thus, a voltage on a node N1 is boosted, and the boosted voltage is applied to the gate of the transistor M3. In other words, a voltage not less than the power potential VDD is applied to the gate of the transistor M3 that is included in the booster circuit and is connected to the power potential VDD at its source or drain. Therefore, a “High” signal at the level of the power potential VDD appears as the output signal OUTPUT. On the other hand, when an input signal INPUT2 supplied from the horizontal scanner 103 undergoes a “High” transition, the transistors M2 and M4 are turned on. Therefore, the potential on the node N1 and the output signal OUTPUT are driven to GND level, so that a “Low” signal appears as the output signal OUTPUT. Through this operation principle, the pulse generates 106 generates, from the pulse supplied from the horizontal scanner 103, pulses necessary for the AD conversion and the counter code generation.

Next, the counter generator 107 will be described. As shown in FIG. 1, the counter generator 107 accepts, as inputs, the output pulse from the horizontal scanner 103 and the pulse generated by the pulse generator 106, generates data (a counter value) working as a digital output value resulting from the AD conversion and outputs the generated data to the memory 105.

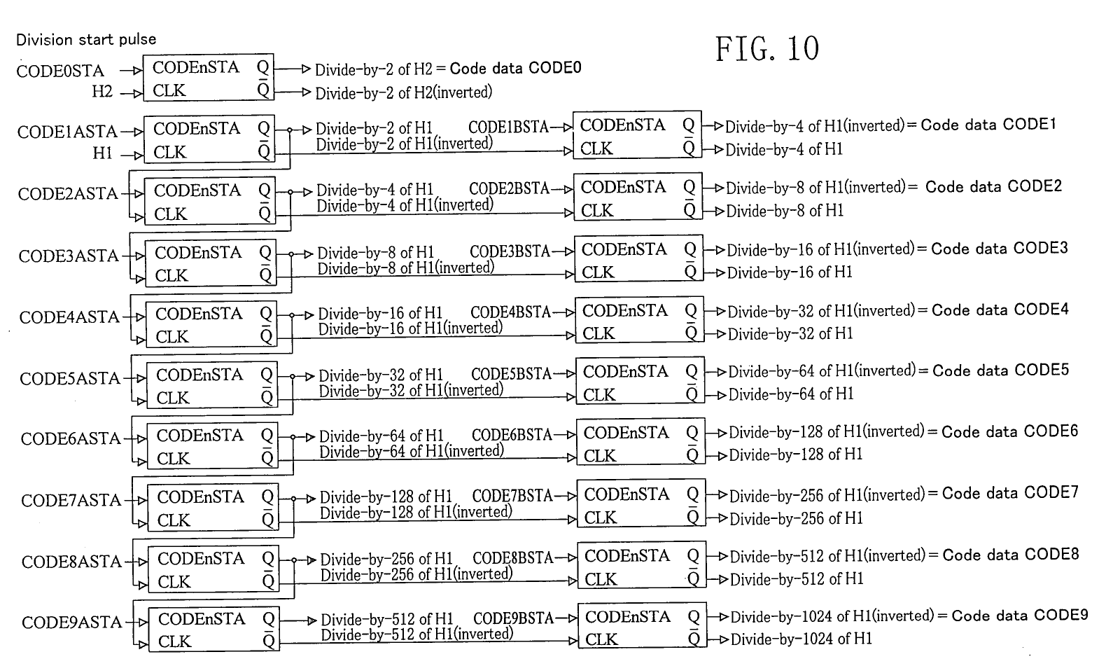

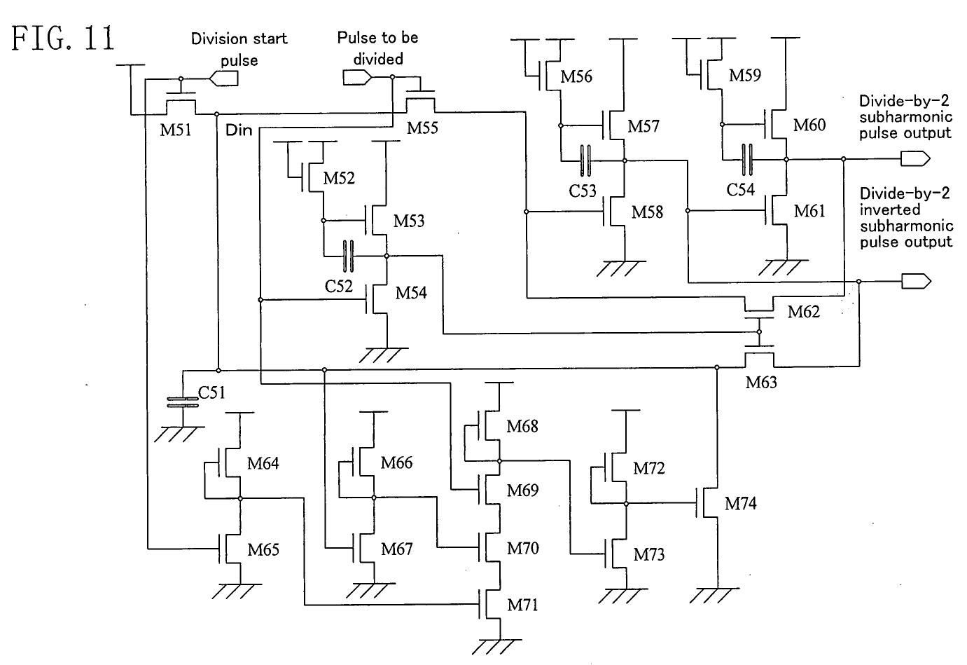

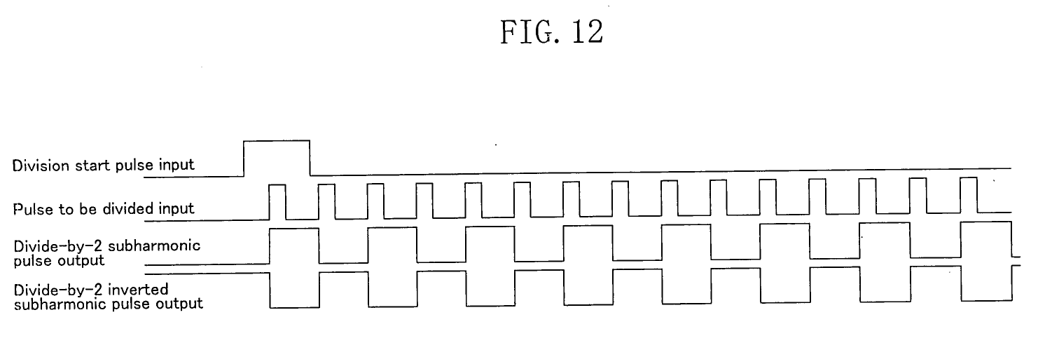

FIG. 10 is a block diagram for showing an example of the circuit configuration of the counter generator 107 using frequency divider circuits of this embodiment, FIG. 11 is a block diagram for showing the configuration of one frequency divider circuit of the counter generator 107 of FIG. 10, and FIG. 12 is an operation timing chart of the counter generator 107 of FIG. 10. In FIG. 11, M51 through M74 indicate N-type MOS transistors and C51 through C54 indicate capacitors.

As shown in FIGS. 10 through 12, the operation of the counter generator 107 is first started by using the pulse generated by the pulse generator 106 and a reference pulse input from the signal processor 150 to the horizontal scanner 103. Then, when a pulse to be divided is input while a division start pulse input CODEnSTA (n=0 through 9) is at “High” level, a signal whose polarity is inverted in synchronization with the pulse to be divided appears as a divide-by-2 subharmonic pulse output CODEn (n=0 through 9). Next, when the pulse to be divided is input with the division start pulse input CODEnSTA placed at “Low” level, the signal whose polarity is inverted in synchronization with the pulse to be divided appears again as the divide-by-2 subharmonic pulse output CODEn. In the counter generator 107, the frequency divider circuits each having the configuration shown in FIG. 11 are cascaded so as to generate the counter value necessary for the AD conversion through the above-described operation principle.

The frequency divider circuit shown in FIG. 11 contains a plurality of inverter circuits each including a booster circuit. The operation of this booster circuit is as follows: Voltages respectively obtained by subtracting the threshold voltages of the transistors M52, M56 and M59 from the power potential VDD are previously applied respectively to the gates of the transistors M53, M57 and M60 that are included in the booster circuit and are connected to the power potential VDD at their sources or drains. Then, when potentials at the gates of the transistors M54, M58 and M61 respectively disposed on the drive sides of the transistors M53, M57 and M60 are at “Low” level, voltages boosted to exceed the power potential VDD are applied to the gates of the transistors M53, M57 and M60, and therefore, the transistors M53, M57 and M60 become completely conductive. Thus, a signal at “High” level can be output without causing the voltage attenuation.

When the above-described booster circuit is used, the rise speed for outputting a signal at “High” level can be easily increased, but the fall speed for outputting a signal at “Low” level is difficult to increase. Therefore, in this embodiment, the gate lengths of the transistors M54, M58 and M61 for driving the outputs of the respective inverter circuits of the frequency divider circuit of FIG. 11 to “Low” level are made relatively small, and the gate widths of these transistors M54, M58 and M61 are made relatively large. Thus, the ON resistances of these transistors are reduced, so that the fall speed can be increased.

Next, the DA converter 108 and the ramp waveform generator 109 will be described. As shown in FIG. 1, the DA converter 108 accepts, as an input, the code data (the counter value) generated by the counter generator 107 and generates an analog signal. Also, the ramp waveform generator 109 accepts, as inputs, an analog signal generated by the DA converter 108 and the pulse generated by the pulse generator 106, and generates a ramp signal necessary for the comparator 104. In this case, transistors included in the DA converter 108 and the ramp waveform generator 109 are all N-type MOS transistors.

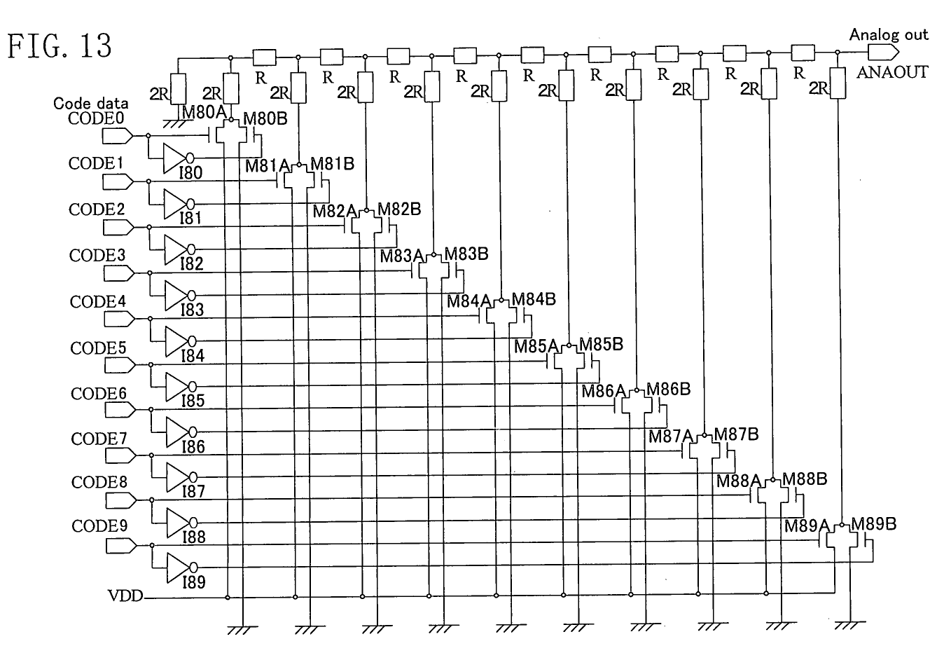

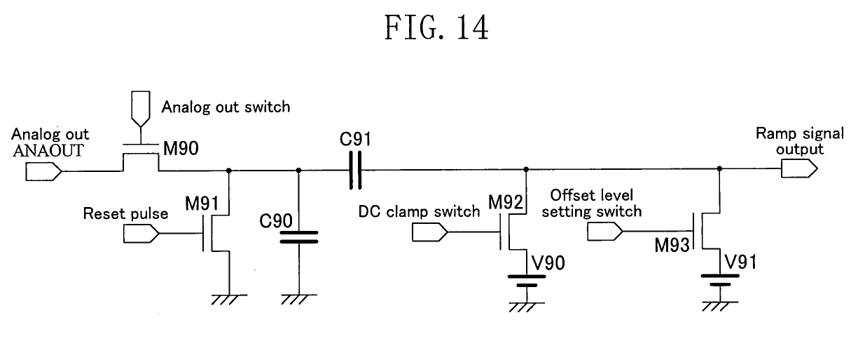

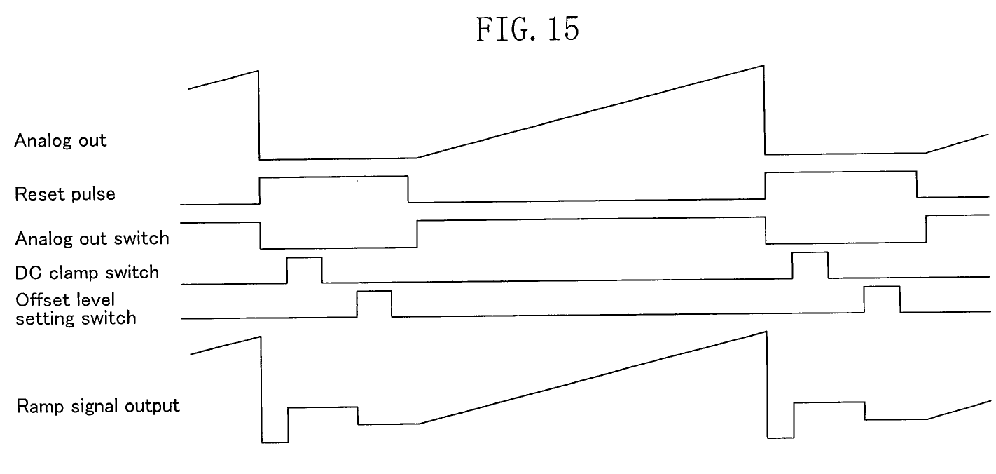

FIG. 13 is a block diagram for showing an example of the circuit configuration of the DA converter 108 of this embodiment, FIG. 14 is a block diagram for showing an example of the circuit configuration of the ramp waveform generator 109 of this embodiment, and FIG. 15 is an operation timing chart of the ramp waveform generator 109 of FIG. 14. In FIG. 13, M80 through M89 indicate N-type MOS transistors, I80 through I89 indicate inverter circuits, and R and 2R are resistors. Also, in FIG. 14, M90 through M93 indicate N-type MOS transistors, C90 and C91 indicate capacitors, and V90 and V91 indicate power sources.

First, as shown in FIG. 13, each bit of the counter value (the code data CODEn) generated by the counter generator 107 is input to the DA converter 108. Also, the DA converter 108 is an R-2R type DA converter, and hence outputs potential in proportion to the counter value as an analog out signal ANAOUT. The analog out signal ANAOUT has a linearly sweeping waveform such as a saw tooth wave (see FIG. 15). Subsequently, in the ramp waveform generator 109 shown in FIG. 14, a pulse (a reset pulse) generated by the pulse generator 106 and the analog out signal ANAOUT generated by the DA converter 108 are applied at timing shown in FIG. 15, so as to generate a ramp signal having a waveform necessary for the AD conversion. Specifically, first, charge of the capacitor C90 is cleared by using the reset switch (transistor) M91, and at the same time, the DC cramp switch (transistor) M92 is turned on so as to once keep the signal level of the ramp signal at potential of the power source V90. Next, the offset level setting switch (transistor) M93 is turned on so as to keep the output level of the ramp signal at potential of the power source V91. Then, after the reset switch (transistor) M91 is turned off, the analog out switch (transistor) M90 is turned on. Thus, a linearly sweeping waveform similar to the analog out signal ANAOUT appears on the basis of the offset level as the ramp signal output.

As described so far, according to the NMOS solid state imaging device of this embodiment, the design of the respective constitution elements (such as the comparator 104 and the memory 105) is optimized by using N-type MOS transistors alone as transistors included therein, so as to convert an analog signal output from the amplifier included in each pixel 101a belonging to a pixel row selected in the pixel unit 101 into a digital signal. In other words, the AD converter using N-type MOS transistors alone as transistors included therein can be contained in the NMOS solid state imaging device. Therefore, an NMOS solid state imaging device capable of digital output can be realized, resulting in remarkably improving the additional value of the NMOS solid state imaging device.

Furthermore, according to the NMOS solid state imaging device of this embodiment, the booster circuit is provided in the comparator 104, and the fall speed from “High” level to “Low” level of the ultimate output characteristic of the inverter circuit I23 disposed at the third stage of the comparator 104 is increased. Accordingly, even though N-type MOS transistors alone are used, the problems of the signal voltage level attenuation, the consumption power increase and the response speed lowering can be prevented.

Moreover, according to the NMOS solid state imaging device of this embodiment, the circuit elements are shared in accordance with their operation characteristics in the memory 105, and therefore, the circuit scale can be reduced. Also, since the booster circuit is provided in the amplifier AMP included in the memory 105, even though N-type MOS transistors alone are used, the problems of the signal voltage level attenuation, the consumption power increase and the response speed lowering can be prevented. As a result, the NMOS solid state imaging device can attain performances at the practical levels.

In addition, since the NMOS solid state imaging device of this embodiment includes the pulse generator 106 for generating a pulse signal on the basis of a column selection signal output by the horizontal scanner 103, a pulse generation circuit included in a signal processor such as a DSP externally provided to a conventional solid state imaging device can be omitted.

Furthermore, according to the NMOS solid state imaging device of this embodiment, since the counter generator 107 for generating a counter value includes the booster circuit for preventing the voltage attenuation of the output signal and accelerating the output signal, the problems of the signal voltage level attenuation, the consumption power increase and the response speed lowering can be more definitely prevented.

Although the comparator 104 and the memory 105 are separately provided in this embodiment, a comparison/storage unit having both the functions of the comparator and the memory can be provided instead.

Although the amplifier AMP is provided as a part of the memory 105 in this embodiment, the amplifier AMP may be provided separately from the memory 105 instead.

What is claimed is:

1. A solid state imaging device using N-type MOS transistors alone as transistors included therein, comprising:
a pixel unit composed of a plurality of pixels arranged in a two-dimensional matrix, each of said pixels including a photoelectric converting element for generating charge in response to light and an amplifying element for outputting, as an analog signal, a voltage signal corresponding to said charge generated by said photoelectric converting element;
a selection signal line provided correspondingly to each pixel row of said pixel unit;
a comparison/storage unit provided correspondingly to each pixel column of said pixel unit for converting, into a digital signal, said analog signal output from said amplifying element included in each pixel belonging to a pixel row selected in said pixel unit and for storing said digital signal;
a scanner for selecting and reading said digital signal stored in said comparison/storage unit in time series; and
an amplifier for amplifying said read digital signal and outputting said amplified digital signal to the outside.

2. The solid state imaging device of claim 1,
wherein said comparison/storage unit includes a comparator, which includes three inverter circuits using N-type MOS transistors alone and serially connected to one another, and a booster circuit for preventing voltage attenuation of an output signal and accelerating said output signal,
in order to increase a fall speed of an inverter circuit disposed at the first stage out of said three inverter circuits, ON resistance of a transistor connected to GND potential is set to be smaller than ON resistance of a transistor connected to power potential in said inverter circuit disposed at the first stage,
in order to increase a rise speed of an inverter circuit disposed at the second stage out of said three inverter circuits, ON resistance of a transistor connected to the power potential is set to be smaller than ON resistance of a transistor connected to the GND potential in said inverter circuit disposed at the second stage, and
in order to increase a fall speed of an inverter circuit disposed at the third stage out of said three inverter circuits, ON resistance of a transistor connected to the GND potential is set to be smaller than ON resistance of a transistor connected to the power potential in said inverter circuit disposed at the third stage.

3. The solid state imaging device of claim 2,
wherein said comparison/storage unit includes a memory, which includes a first switch for reading a counter value on the basis of a signal supplied from said comparator, a capacitor for storing said read counter value, a second switch for transferring said counter value stored in said capacitor, a third switch for deleting said transferred counter value, a fourth switch for reading said transferred counter value on the basis of a signal supplied from said scanner, and said amplifier for outputting said read counter value to the outside, and
said amplifier includes a booster circuit for preventing voltage attenuation of an output signal thereof and accelerating said output signal.

4. The solid state imaging device of claim 3, further comprising:
a pulse generator for generating a pulse signal on the basis of a column selection signal output from a horizontal scanner included in said scanner; and
a counter generator for generating said counter value on the basis of said pulse signal generated by said pulse generator.

5. The solid state imaging device of claim 4,
wherein said counter generator includes a booster circuit for preventing voltage attenuation of an output signal thereof and accelerating said output signal.

6. The solid state imaging device of claim 4, further comprising a ramp waveform generator for generating a ramp signal on the basis of said pulse signal generated by said pulse generator and said counter value generated by said counter generator.

7. A solid state imaging device, comprising:
a pixel unit formed on a semiconductor substrate and outputting, as an analog signal, a voltage signal corresponding to light; and
an AD converter formed on said semiconductor substrate and converting said analog signal output from said pixel unit into a digital signal,
wherein transistors included in said pixel unit and said AD converter are all N-type MOS transistors, and
said AD converter includes a booster circuit.

8. The solid state imaging device of claim 7,
wherein said booster circuit includes a transistor whose source or drain is connected to power potential, and
a voltage not less than said power potential is applied to a gate of said transistor.

9. The solid state imaging device of claim 7,
wherein said AD converter includes, in addition to said booster circuit, any or all of a comparator, a memory, a pulse generator and a counter generator.

10. The solid state imaging device of claim 9,
wherein said comparator includes an inverter circuit having said booster circuit,
said booster circuit includes a first transistor whose source or drain is connected to power potential, and
a voltage not less than said power potential is applied to a gate of said first transistor.

11. The solid state imaging device of claim 9,
wherein said comparator includes an inverter circuit having said booster circuit,
said inverter circuit has a second transistor formed above a well region independent of other well regions, and
a gate and a source of said second transistor are electrically connected to said well region.

12. The solid state imaging device of claim 9,
wherein said memory includes a plurality of switches, a capacitor and an output amplifier,
said output amplifier includes a booster circuit,
said booster circuit has a transistor whose source or drain is connected to power potential, and
a voltage not less than said power potential is applied to a gate of said transistor.

13. The solid state imaging device of claim 12, further comprising a scanner for selecting and reading a digital signal obtained by said AD converter in time series,
wherein said memory includes a first switch for reading a counter value on the basis of a signal supplied from said comparator, a capacitor for storing said read counter value, a second switch for transferring said counter value stored in said capacitor, a third switch for deleting said transferred counter value, a fourth switch for reading said transferred counter value on the basis of a signal supplied from said scanner, and an output amplifier for outputting said read counter value to the outside.

14. The solid state imaging device of claim 9, further comprising a scanner for selecting and reading a digital signal obtained by said AD converter in time series,
wherein said pulse generator generates a pulse signal on the basis of a column selection signal output from a horizontal scanner included in said scanner and includes a plurality of inverter circuits serially connected to one another,
an inverter circuit disposed at the ultimate stage out of said plurality of inverter circuits includes a booster circuit,
said booster circuit has a transistor whose source or drain is connected to power potential, and
a voltage not less than said power potential is applied to a gate of said transistor.

15. The solid state imaging device of claim 9,
wherein said counter generator generates a counter value on the basis of a pulse signal generated by said pulse generator and includes a plurality of inverter circuits each having a booster circuit,
said booster circuit has a transistor whose source or drain is connected to power potential, and
a voltage not less than said power potential is applied to a gate of said transistor.
